(19) United States
(12) Patent Application Publication
(10) Pub. No.: US 2015/0280905 A1
(43) Pub. Date: Oct. 1, 2015

(54) METHOD AND APPARATUS FOR DETECTING AND CORRECTING PDCP HYPER FRAME NUMBER (HFN) DESYNCHRONIZATION

(71) Applicant: Telefonaktiebolaget L M Ericsson (publ), Stockholm (SE)

(72) Inventors: Samir Shah, Ottawa (CA); Adrian Turcanu, Ottawa (CA); John Fong, Ottawa (CA)

(73) Assignee: Telefonaktiebolaget L M Ericsson (publ), Stockholm (SE)

(21) Appl. No.: 14/242,253

(22) Filed: Apr. 1, 2014

(51) Int. Cl. H04L 7/04; H04L 12/823

(52) U.S. Cl. CPC H04L 7/048; H04L 47/32

(57) ABSTRACT

Systems and methods for detecting and correcting Hyper Frame Number (HFN) desynchronization between a first radio node and a second radio node are disclosed. In one embodiment, a first radio node receives a Packet Data Convergence Protocol (PDCP) Packet Data Unit (PDU) from a second radio node and deciphers the PDCP PDU based on a PDCP Sequence Number (SN) contained in the PDCP PDU and a HFN maintained at the first radio node. The first radio node detects a PDCP SN gap with respect to the PDCP SN contained in the PDCP PDU and, in response, determines whether a HFN desynchronization condition exists between the first radio node and the second radio node. In response to determining that a HFN desynchronization condition exists between the first radio node and the second radio node, the first radio node increments the HFN maintained at the first radio node.

### FIELD OF THE DISCLOSURE

The present disclosure relates to detecting and correcting Packet Data Convergence Protocol (PDCP) Hyper Frame Number (HFN) desynchronization between radio nodes in a cellular communications network.

### BACKGROUND

In a 3^{rd} Generation Partnership Project (3GPP) Long Term Evolution (LTE) cellular network, a Packet Data Convergence Protocol (PDCP) is utilized at both the wireless device (e.g., the User Equipment (UE)) and the radio access node (e.g., the evolved Node B (eNB)). The PDCP for LTE is defined in 3GPP Technical Specification (TS) 36.323 V11.2.0, which is entitled “Technical Specification Group Radio Access Network; Evolved Universal Terrestrial Radio Access (E-UTRA); Packet Data Convergence Protocol (PDCP) specification (Release 11).” The PDCP supports functions such as, for example, header compression and decompression of Internet Protocol (IP) packets using a Robust Header Compression (RoHC) protocol, transfer of data (e.g., user plane data or control plane data), maintenance of PDCP Sequence Numbers (SNs), in-sequence delivery of upper layer Packet Data Units (PDUs) at re-establishment of lower layers, ciphering and deciphering of user plane data and control plane data, integrity protection and integrity verification of control plane data, timer based discard, etc. RoHC is defined in Internet Engineering Task Force (IETF) Request for Comment (RFC) 3095, “RObust Header Compression (ROHC): Framework and four profiles: RTP, UDP, ESP, and uncompressed.”

The parameters that are required by PDCP for ciphering and deciphering are defined in 3GPP TS 33.401 Release 12, which is entitled “Technical Specification Group Services and System Aspects; 3GPP System Architecture Evolution (SAE); Security architecture.” The parameters required by PDCP for ciphering include:
KEY: A 128-bit cipher key.
COUNT: Hyper Frame Number (HFN)+PDCP SN.
BEARER: A radio bearer Identifier (ID).
DIRECTION: A direction of the radio bearer (i.e., uplink or downlink).
LENGTH: A length of a ciphering keystream to be generated by the ciphering algorithm.

As indicated above, the COUNT parameter is formed by combining the HFN and the PDCP sequence number. Note that the COUNT parameter is itself a sequence number used for ciphering/deciphering as well as integrity protection in the PDCP layer. A given sequence number (COUNT) must only be used once for a given KEY on the same radio bearer in the same direction. The same sequence number (COUNT) can be used for both ciphering/deciphering and integrity protection. The PDCP SN is a 5, 7, or 12 bit value assigned to a PDCP PDU. PDCP PDUs transmitted from a PDCP transmitter to a PDCP receiver are assigned PDCP SNs in sequential order. The HFN is an overflow counter mechanism used in order to limit the actual number of PDCP SN bits that are needed to be sent over the air interface in the PDCP PDUs. The HFN needs to be synchronized between the transmitter and the receiver. In other words, when the PDCP SN has reached its maximum value (which in turn depends on the number of bits used for PDCP SN (5, 7, or 12 bits), the PDCP SN will be restarted from 0 and the HFN will be increased by one.

In operation, at a PDCP transmitter, the input parameters are input to a ciphering algorithm that then outputs a ciphering keystream. A message to be transmitted by the PDCP transmitter is then masked (e.g., XOR operation) by the ciphering keystream to provide a PDCP PDU that is then transmitted to a PDCP receiver via one or more lower layers. Importantly, the PDCP SN is included in a header of the PDCP PDU, whereas the PDCP HFN is not. At the PDCP receiver, the PDCP SN is extracted from the header of the PDCP PDU and combined with a PDCP HFN maintained locally by the PDCP receiver to provide the COUNT parameter for deciphering. The PDCP receiver then passes the COUNT parameter along with the other parameters required by PDCP to the ciphering algorithm that then outputs a ciphering keystream. This ciphering keystream should be the same as that used by the PDCP transmitter. The PDCP receiver then deciphers the PDCP PDU using the ciphering keystream to provide a deciphered PDCP PDU. The deciphered user plane data PDCP PDU may be an IP packet or a RoHC compressed IP packet.

One issue that arises is HFN desynchronization. HFN desynchronization occurs when the HFN at the PDCP transmitter is not the same as (i.e., not synchronized with) the HFN at the PDCP receiver. While this may occur in various scenarios, in one example, HFN desynchronization may occur when a wireless device, or UE, is at the cell edge of a cell of a serving base station of the wireless device (or in a situation where there is temporary loss of radio reception). In this scenario, if a significant number of packets are lost or discarded in a row, the HFN maintained at the PDCP receiver (i.e., the PDCP RX_HFN) will get out-of-sync with the HFN maintained at the PDCP transmitter (i.e., the PDCP TX_HFN). This leads to a loss of the ability to correctly decipher any future received PDCP PDUs at the PDCP receiver due to an incorrect COUNT parameter for deciphering at the PDCP receiver. Another example of when HFN desynchronization is likely to occur is when PDCP timer discard is enabled at the PDCP transmitter. If there is a long time before the wireless device is scheduled to transmit (e.g., due to high load) when PDCP timer discard is enabled, the PDCP transmitter may discard a large number of packets that have already been ciphered and assigned PDCP SNs. This results in a gap in the PDCP SNs at the PDCP receiver. If this gap in the PDCP SNs extends across a HFN boundary, the HFNs at the PDCP transmitter and the PDCP receiver will become out-of-sync. In addition, the probability of HFN desynchronization increases for Unacknowledged Mode (UM) bearers in poor Radio Frequency (RF) conditions since packet delivery is not guaranteed, especially when a short PDCP SN is used. HFN desynchronization is more likely on user-plane data bearers.

Currently in the LTE specifications, there is no mention of how HFN desynchronization can be detected and the only way to recover from HFN desynchronization between a wireless device, or UE, and a radio access node (e.g., an eNB) is by a UE release followed by a re-attach/re-establishment of the UE and the corresponding radio bearer(s) (see, e.g., Section 14.1 of 3GPP TS 36.300 Release 12, entitled “Technical Specification Group Radio Access Network; Evolved Universal Terrestrial Radio Access (E-UTRA) and Evolved Universal Terrestrial Radio Access Network (E-UTRAN); Overall description; Stage 2 (Release 12). This approach is a disruptive method of dealing with HFN desynchronization and, in case of a Voice over IP (VoIP) call, would lead to a call drop.

Further, while the HFN desynchronization condition exists, all the packets flowing on the affected bearers in the direction of the HFN desynchronization will be corrupted, rendering the data packets unusable and leading to a decrease in the quality of experience for the customer. Note that packets flow in both directions on a bearer, but the HFN desynchronization may occur only in one direction. In addition, when HFN desynchronization occurs on the uplink path, incorrect deciphering occurs at the radio access node. Unless the corruption is detected within the radio access node, malformed packets can be forwarded into the core network of the cellular network, creating unnecessary backhaul network traffic.

U.S. Patent Application Publication No. 2006/0050679 A1, entitled “Method for On-Line Recovery of Parameter Synchronization for Ciphering Applications,” discloses a method for restoring HFN synchronization in a Wideband Code Division Multiple Access (WCDMA) cellular network. However, this method is performed in the Radio Link Control (RLC) layer and provides no mechanism by which to handle RoHC packets (RoHC is not employed in the WCDMA RLC layer). Further, the disclosed method of detecting HFN desynchronization is based on heuristic measurements of Length Indicator (LI) fields in the RLC packets. This approach is WCDMA-specific and is not applicable to LTE.

U.S. Pat. No. 8,243,931 B2, entitled “Method for Detecting Security Error in Mobile Telecommunications System and Device of Mobile Telecommunications,” discloses a method for detecting a security error at a PDCP layer of an LTE system. In particular, a receiving side PDCP layer determines whether HFN desynchronization has occurred. If HFN desynchronization has occurred, the receiving side PDCP layer informs a Radio Resource Control (RRC) layer to reestablish a radio bearer or perform a PDCP reset procedure to reset security configuration of a transmitting side and the receiving side. However, correction of the HFN desynchronization requires signaling (e.g., RRC signaling). Further, the disclosed methods of HFN desynchronization detection assume that all packets are RoHC-compressed, which is not the case in a real world deployment. Further, the disclosed method does not distinguish between genuine HFN desynchronization and RoHC content desynchronization.

U.S. Patent Application Publication No. 2012/0308009 A1, entitled “Mechanisms for Detection of and Recovery from Ciphering Parameter Mismatch on Communication Networks,” discloses methods for detecting mismatch of ciphering parameters and recovery therefrom. The methods are performed in the RLC layer, where mismatch of ciphering parameters is detected by examining a predefined ciphered field, such as a LI field, in one or more received RLC PDUs. Mismatch of ciphering parameters is determined when a predetermined number of samples of the predefined ciphered field exceed a predetermined threshold. When a mismatch is detected, recovery of RLC PDUs is performed by using a range of HFNs to decipher buffered RLC PDUs and then determining which HFN corrects the mismatch. However, the disclosed methods are performed in the RLC layer and provide no mechanism by which to handle RoHC packets (RoHC is not employed in the WCDMA RLC layer). In LTE, ciphering is not performed in the RLC layer. Further, the disclosed methods of detecting mismatch of ciphering parameters are based on heuristic measurements of the LI fields in the RLC packets. This approach is WCDMA-specific and is not applicable to LTE.

In light of the discussion above, there is a need for improved systems and methods for detecting and correcting HFN desynchronization, particularly in LTE cellular networks and where some packets may be RoHC-compressed.

### SUMMARY

The present disclosure relates to detecting and correcting Hyper Frame Number (HFN) desynchronization between a first radio node and a second radio node. In one embodiment, a method of operation of a first radio node is provided. The method of operation of the first radio node includes receiving a Packet Data Convergence Protocol (PDCP) Packet Data Unit (PDU) from a second radio node and deciphering the PDCP PDU based on a PDCP Sequence Number (SN) contained in the PDCP PDU and a HFN maintained at the first radio node. The method further includes detecting a PDCP SN gap with respect to the PDCP SN contained in the PDCP PDU and, in response to detecting the PDCP SN gap, determining whether a HFN desynchronization condition exists between the first radio node and the second radio node. In response to determining that a HFN desynchronization condition exists between the first radio node and the second radio node, the method further includes incrementing the HFN maintained at the first radio node. In this manner, an attempt to repair, or correct, the HFN desynchronization condition is made while maintaining an associated radio bearer and without exchanging information between the first and second radio nodes. Further, by checking for a gap in the PDCP SN before determining whether there is a HFN desynchronization condition, fewer PDCP PDUs are processed by the HFN desynchronization procedure, which in turn saves computing cycles since there is a very low probability of HFN desynchronization without a gap in the PDCP SN occurring.

In one embodiment, the method of operation of the first radio node further includes receiving a new PDCP PDU from the second radio node, deciphering the new PDCP PDU based on a PDCP sequence number contained in the new PDCP PDU and the HFN, determining that the HFN desynchronization condition still exists between the first radio node and the second radio node, and further incrementing the HFN maintained at the first radio node in response to determining that the HFN desynchronization condition still exists.

In one embodiment, the method of operation of the first radio node further includes repeating a process of receiving a new PDCP PDU from the second radio node, deciphering the new PDCP PDU based on a PDCP sequence number contained in the new PDCP PDU and the HFN maintained by the first radio node, determining whether the HFN desynchronization condition still exists, and further incrementing the HFN maintained by the first radio node if the HFN desynchronization condition still exists until either the HFN desynchronization condition no longer exists or a maximum number of HFN correction attempts has been reached.

In one embodiment, determining whether the HFN desynchronization condition exists includes performing a HFN desynchronization detection procedure that distinguishes between HFN-desynchronization and Robust Header Compression (RoHC) context desynchronization.

In another embodiment, a first radio node is provided. In one embodiment, the first radio node includes a transceiver, a processor, and memory containing instructions executable by the processor by whereby the first radio node is operative to: receive, via the transceiver, a PDCP PDU from a second radio node; decipher the PDCP PDU based on a PDCP SN contained in the PDCP PDU and a HFN maintained at the first radio node; detect a PDCP SN gap with respect to the PDCP SN included in the PDCP PDU; and in response to detecting that there is a PDCP SN gap, determine whether a HFN desynchronization condition exists between the first radio node and the second radio node; and, in response to determining that a HFN desynchronization condition exists between the first radio node and the second radio node, increment the HFN maintained at the first radio node.

Those skilled in the art will appreciate the scope of the present disclosure and realize additional aspects thereof after reading the following detailed description of the embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a cellular network including a base station and a wireless device, where one or both of the base station and the wireless device perform Hyper Frame Number (HFN) desynchronization detection and correction according to one embodiment of the present disclosure;

FIG. 2 is a block diagram of a radio node, e.g., either the base station or the wireless device of FIG. 1, including a HFN desynchronization detection and correction function within a Packet Data Convergence Protocol (PDCP) layer of a protocol stack of the radio node according to one embodiment of the present disclosure;

FIG. 3 is a flow chart that illustrates a HFN desynchronization detection and correction process according to one embodiment of the present disclosure;

FIG. 4 is a flow chart that illustrates a HFN desynchronization detection and correction process according to another embodiment of the present disclosure;

FIG. 5 is a flow chart that illustrates a HFN desynchronization detection and correction process according to another embodiment of the present disclosure;

FIG. 6 is a flow chart that illustrates the packet deciphering sanity check procedure of FIG. 5 in more detail according to one embodiment of the present disclosure;

FIG. 7 is a block diagram of the base station of FIG. 1 according to one embodiment of the present disclosure;

FIG. 8 is a block diagram of the wireless device of FIG. 1 according to one embodiment of the present disclosure; and

FIG. 9 is a block diagram of a radio node, e.g., either the base station or the wireless device of FIG. 1, according to one embodiment of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Hyper Frame Numbers (HFNs) are utilized for, e.g., ciphering and deciphering Packet Data Convergence Protocol (PDCP) Packet Data Units (PDUs) transmitted from a PDCP transmitter (e.g., a PDCP layer in a protocol stack of a first radio node) to a PDCP receiver (e.g., a PDCP layer in a protocol stack of a second radio node). In particular, in a 3^{rd} Generation Partnership Project (3GPP) Long Term Evolution (LTE) cellular network, the PDCP layer is defined in 3GPP TS 36.323 V11.2.0, which is entitled “Technical Specification Group Radio Access Network; Evolved Universal Terrestrial Radio Access (E-UTRA); Packet Data Convergence Protocol (PDCP) specification (Release 11).” The PDCP layer supports functions such as, for example, header compression and decompression of Internet Protocol (IP) packets using a Robust Header Compression (RoHC) protocol, transfer of data (e.g., user plane data or control plane data), maintenance of PDCP Sequence Numbers (SNs), ciphering and deciphering of user plane data and control plane data, integrity protection and integrity verification of control plane data, timer based discard, etc.

Ciphering and deciphering of user plane data and control plane data is based on a number of parameters including a COUNT parameter. The COUNT parameter is a combination of the HFN and a PDCP SN. The PDCP SN is a 5, 7, or 12 bit value assigned to a PDCP PDU. PDCP PDUs transmitted from a PDCP transmitter to a PDCP receiver are assigned PDCP SNs in sequential order. The HFN is an overflow counter mechanism used in order to limit the actual number of PDCP SN bits that is needed to be sent over the air interface in the PDCP PDUs. The HFN needs to be synchronized between the transmitter and the receiver. In other words, when the PDCP SN has reached its maximum value (which in turn depends on the number of bits used for PDCP SN (5, 7, or 12 bits), the PDCP SN will be restarted from 0 and the HFN will be increased by one. While the PDCP SN is included in the PDCP PDU, the HFN is independently maintained by each of the PDCP transmitter and the PDCP receiver. HFN desynchronization occurs when the HFN maintained at the PDCP receiver (i.e., the HFN maintained by the PDCP layer at the receiving radio node) becomes out-of-sync with the HFN maintained at the PDCP transmitter (i.e., the HFN maintained by the PDCP layer at the transmitting radio node).

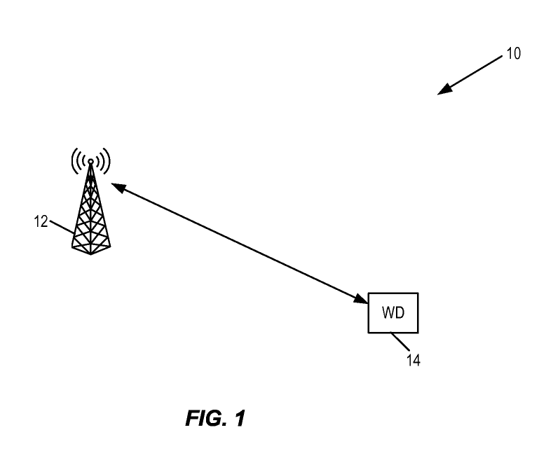

Systems and methods are disclosed herein for detecting and correcting HFN desynchronization between a first radio node and a second radio node. In this regard, FIG. 1 illustrates a cellular network 10 that includes a base station 12 and a wireless device 14, one or both of which perform HFN desynchronization detection and correction according to one embodiment of the present disclosure. In the embodiments described herein, the cellular network 10 is a 3GPP LTE network and, as such, the base station 12 may be referred to as an enhanced Node B (eNB), and the wireless device 14 may be referred to as a User Equipment (UE). However, the embodiments described herein are not limited to 3GPP LTE. Further, the HFN desynchronization detection and correction schemes described herein may be performed by the base station 12 and/or the wireless device 14. However, the present disclosure is not limited thereto. The HFN desynchronization detection and correction schemes described herein may be used in any suitable radio node. As used herein, a radio node is any wireless communication node in the cellular network 10 (e.g., a base station, a wireless device/UE, a relay, a remote radio head, etc.).

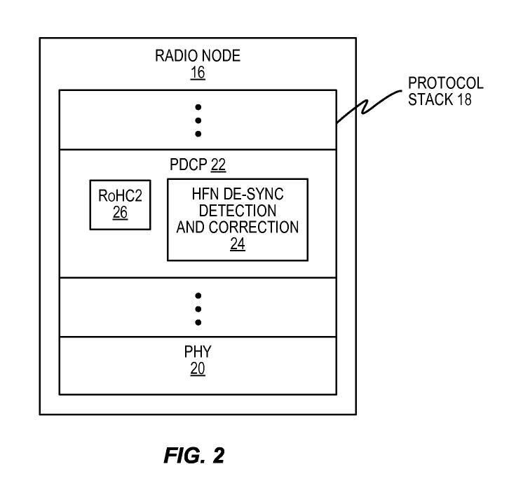

FIG. 2 illustrates a radio node 16 according to one embodiment of the present disclosure. The radio node 16 may be, e.g., the base station 12 or the wireless device 14 of FIG. 1. However, the radio node 16 is not limited thereto. As illustrated, the radio node 16 includes a protocol stack 18, which is implemented as a combination of hardware and software. While the protocol stack 18 includes many layers (e.g., a Physical (PHY) layer 20, etc.), for the description herein, it is important to note that the protocol stack 18 includes a PDCP layer 22. The PDCP layer 22 includes a HFN desynchronization detection and correction function 24. In some embodiments, the PDCP layer 22 also includes a RoHC function 26. While not illustrated, the PDCP layer 22 also includes, or performs, other functions such as, for example, ciphering, deciphering, PDCP SN maintenance, HFN maintenance, etc.

As discussed below in detail, the HFN desynchronization detection and correction function 24 operates to detect HFN desynchronization for a PDCP connection (i.e., a PDCP connection over a radio bearer between the radio node 16, e.g., the base station 12, and another radio node, e.g., the wireless device 14). Upon detecting the HFN desynchronization, the HFN desynchronization detection and correction function 24 attempts to correct the HFN maintained by the radio node 16. This correction is attempted while maintaining the radio bearer and without sending any information to or receiving any information from the other radio node. Such detection and correction are not currently defined in the 3GPP LTE specifications. Currently, the 3GPP LTE specifications do not define any method for detecting HFN desynchronization, particularly in the PDCP layer 22. Further, the only method for recovering from a HFN desynchronization condition defined in the current 3GPP LTE specifications is by a UE release followed by a re-attach of the UE and the corresponding radio bearer(s).

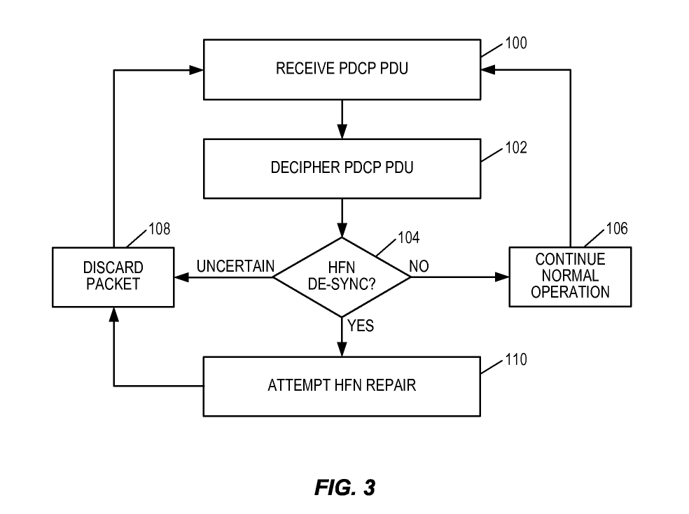

FIG. 3 is a flow chart that illustrates the operation of the radio node 16 of FIG. 2 (e.g., either the base station 12 or the wireless device 14) to perform HFN desynchronization detection and correction according to one embodiment of the present disclosure. This process is performed by the PDCP layer 22. Further, this process is performed for a particular PDCP connection over a single radio bearer between the radio node 16 and another radio node. However, multiple instances of this process may be performed in parallel for multiple PDCP connections over corresponding radio bearers. In other words, the PDCP layer 22 includes one uplink PDCP entity (a PDCP transmitter) and one downlink PDCP entity (a PDCP receiver) per configured radio bearer. Each PDCP receiver performs the process of FIG. 3.

As illustrated, the PDCP layer 22, which in this case is operating as a PDCP receiver, receives a PDCP PDU from a PDCP layer (i.e., a PDCP transmitter) of another radio node (step 100). The PDCP layer 22 then deciphers the PDCP PDU (step 102). In one embodiment, the PDCP PDU is deciphered into either an IP packet or a RoHC compressed IP packet (if RoHC is enabled), each of which are generally referred to herein as a deciphered PDCP PDU. More specifically, in 3GPP LTE, the PDCP layer 22 inputs a number of parameters including the COUNT parameter into a ciphering algorithm that then generates a ciphering keystream based on the input parameters. As discussed above, the COUNT parameter is a combination of a HFN maintained by the PDCP layer 22 and a PDCP SN included in the received PDCP PDU. The PDCP layer 22 then deciphers the received PDCP PDU using the generated ciphering keystream.

The HFN desynchronization detection and correction function 24 of the PDCP layer 22 then determines whether a HFN desynchronization condition exists (step 104). If a HFN desynchronization condition does not exist, the PDCP layer 22 continues normal operation (step 106), and then the process returns to step 100 to process the next received PDCP PDU. As discussed below, there may be scenarios in which the HFN desynchronization detection and correction function 24 may be uncertain as to whether a HFN desynchronization condition exists. In this case, if the HFN desynchronization detection and correction function 24 is uncertain as to whether a HFN desynchronization condition exists, the PDCP layer 22 discards the PDCP PDU (step 108), and then the process returns to step 100 to process the next received PDCP PDU.

If the HFN desynchronization detection and correction function 24 determines that a HFN desynchronization condition exists, the HFN desynchronization detection and correction function 24 attempts to repair the HFN maintained by the PDCP layer 22 (step 110) and discards the PDCP PDU (step 108). A HFN desynchronization condition occurs when, due to some reason, PDCP PDUs are discarded by the PDCP transmitter (e.g., due to PDCP discard timer) or lost (e.g., due to poor Radio Frequency (RF) conditions). Because discarded or lost PDCP PDUs were assigned PDCP SNs by the PDCP transmitter before being discarded as lost, a gap in the sequence of PDCP SNs occurs at the PDCP receiver (i.e., the PDCP layer 22). If this gap in PDCP SNs crosses one or more HFN boundaries, the HFN maintained by the PDCP layer 22 becomes out-of-sync with the HFN maintained by the PDCP transmitter (i.e., the PDCP layer at the transmitting radio node). More specifically, if the gap in the PDCP SNs crosses a single HFN boundary (i.e., a single rollover of the PDCP SN), then the HFN maintained by the PDCP layer 22 (i.e., the PDCP receiver) becomes 1 less than the HFN maintained by the PDCP transmitter (i.e., the PDCP layer of the transmitting radio node). More generally, if the gap in the PDCP SNs crosses multiple (M) HFN boundaries (i.e., M rollovers of the PDCP SN), then the HFN maintained by the PDCP layer 22 (i.e., the PDCP receiver) becomes M less than the HFN maintained by the PDCP transmitter (i.e., the PDCP layer of the transmitting radio node). By incrementing the HFN at the PDCP layer 22, the HFN desynchronization detection and correction function 24 is attempting to repair the HFN desynchronization condition.

Once the HFN desynchronization detection and correction function 24 attempts to repair the HFN desynchronization condition and the PDCP PDU is discarded, the process returns to step 100 and is repeated for the next received PDCP PDU. While not illustrated in FIG. 3, a maximum number of HFN repair, or correction, attempts may be predefined for the PDCP layer 22, e.g., by a standard or by the cellular network 10. Once this maximum number of HFN repair attempts has been made without success, the PDCP layer 22 may initiate a global repair procedure. The global repair procedure may be, e.g., a release of the radio bearer followed by re-attachment or re-establishment, an intra-cell handover (e.g. as described in Section 14.3.3 of 3GPP TS 36.300), or forcing the wireless device 14 to IDLE (in the scenario where the radio node 16 is either the base station 12 or the wireless device 14 of FIG. 1). Note that different global repair procedures may be performed for Acknowledged Mode (AM) and Unacknowledged Mode (UM) bearers. For instance, a release followed by a re-attachment can be used for either AM or UM bearers. However, for UM bearers, a more efficient global repair procedure is an intra-cell handover. Thus, in one embodiment, the global repair procedure is a release followed by a re-attachment if the radio bearer is an AM bearer or an intra-cell handover if the radio bearer is a UM bearer.

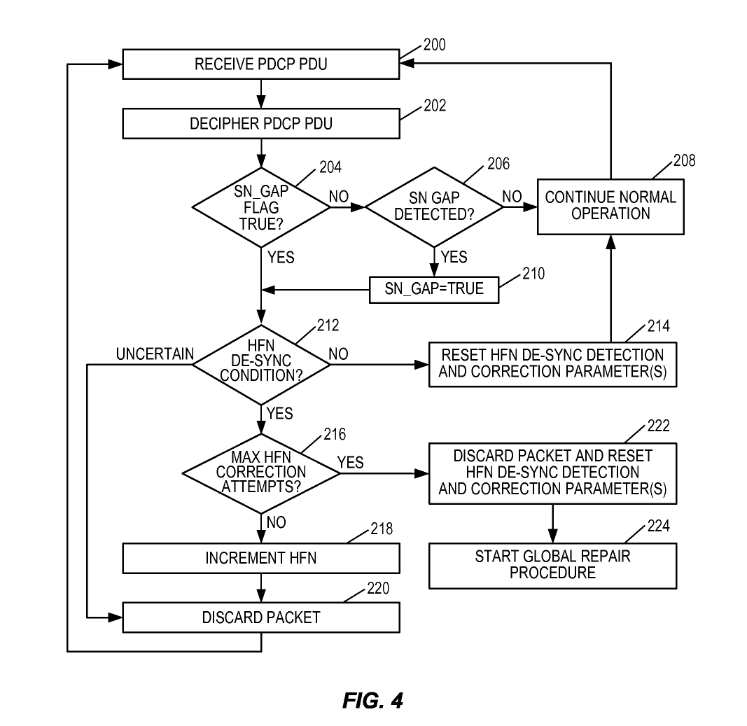

FIG. 4 is a flow chart that illustrates the operation of the radio node 16 of FIG. 2 (e.g., either the base station 12 or the wireless device 14) to perform HFN desynchronization detection and correction according to another embodiment of the present disclosure. This process is performed by the PDCP layer 22. Further, this process is performed for a particular PDCP connection over a single radio bearer between the radio node 16 and another radio node. However, multiple instances of this process may be performed in parallel for multiple PDCP connections over corresponding radio bearers. In other words, the PDCP layer 22 includes one uplink PDCP entity (a PDCP transmitter) and one downlink PDCP entity (a PDCP receiver) per configured radio bearer. Each PDCP receiver performs the process of FIG. 3.

As illustrated, the PDCP layer 22, which in this case is operating as a PDCP receiver, receives a PDCP PDU from a PDCP layer (i.e., a PDCP transmitter) of another radio node (step 200). The PDCP layer 22 then deciphers the PDCP PDU, as discussed above (step 202). In this embodiment, before performing the HFN desynchronization detection and correction process, the HFN desynchronization detection and correction function 24 of the PDCP layer 22 determines whether a PDCP SN gap flag (SN_GAP) is set to TRUE (step 204). Initially, the PDCP SN gap flag (SN_GAP) is set to FALSE. However, as discussed below, once the PDCP layer 22 detects a gap in the PDCP SNs, the PDCP layer 22 sets the PDCP SN gap flag (SN_GAP) to TRUE.

If the PDCP SN gap flag (SN_GAP) is not TRUE (i.e., is FALSE), the PDCP layer 22 determines whether a gap in the PDCP SNs is detected (step 206). A gap in the PDCP SNs is detected when there is a gap between the PDCP SN in the received PDCP PDU and the PDCP SN of the immediately preceding PDCP PDU received by the PDCP layer 22. If no gap is detected, the PDCP layer 22 continues normal operation (step 208), and the process then returns to step 200 and is repeated for the next received PDCP PDU. However, if a gap in the PDCP SNs is detected, the PDCP layer 22 sets the PDCP SN gap flag (SN_GAP) to TRUE (step 210). Note that, in some alternative embodiments, steps 204, 206, and 210 are not performed. In other words, the HFN desynchronization detection is performed on all deciphered PDCP PDUs without first determining if there is a gap in the sequence of PDCP SNs.

If the PDCP SN gap flag (SN_GAP) is determined to be TRUE in step 204 or if the PDCP SN gap flag (SN_GAP) is set to TRUE in step 210, the HFN desynchronization detection and correction function 24 then triggers a HFN desynchronization detection and correction procedure. By triggering the HFN desynchronization detection and correction procedure only when the PDCP SN gap flag (SN_GAP) is TRUE, processing resources are conserved by not performing the HFN desynchronization detection and correction procedure for all PDCP PDUs. In this embodiment, in order to perform the HFN desynchronization detection and correction procedure, the HFN desynchronization detection and correction function 24 determines whether a HFN desynchronization condition exists (step 212). If the HFN desynchronization detection and correction function 24 determines that a HFN desynchronization condition does not exist, the HFN desynchronization detection and correction function 24 resets all HFN desynchronization detection and correction parameters (e.g., SN_GAP flag, a HFN correction attempt counter, etc.) (step 214), and the PDCP layer 22 continues normal operation (step 208). The process then returns to step 200 and is repeated for the next received PDCP PDU.

Returning to step 212, if the HFN desynchronization detection and correction function 24 is uncertain as to whether a HFN desynchronization detection condition exists, the HFN desynchronization detection and correction function 24 proceeds to step 220 where the PDCP PDU is discarded, as discussed below. Conversely, if the HFN desynchronization detection and correction function 24 determines that a HFN desynchronization condition does exist, the HFN desynchronization detection and correction function 24 determines whether a maximum number of HFN correction attempts has been made to correct this HFN desynchronization condition (step 216). If not, the HFN desynchronization detection and correction function 24 increments the HFN maintained by the PDCP layer 22 (step 218) and discards the PDCP PDU (step 220). At this point, a counter for the number of HFN correction attempts is also incremented. The process then returns to step 200 and is repeated for the next received PDCP PDU. Notably, when deciphering the next received PDCP PDU, the new, or incremented, HFN is utilized.

Returning to step 216, if the HFN desynchronization condition is not corrected within the maximum number of HFN correction attempts, the HFN desynchronization detection and correction function 24 discards the PDCP PDU and resets all parameters for HFN desynchronization detection and correction (step 222). The HFN desynchronization detection and correction function 24 then starts, or initiates, a global repair procedure (step 224). At this point, the process ends. In particular, in one embodiment, the global repair procedure releases the radio bearer and the PDCP connection is lost. Thereafter, when the radio bearer is re-established, a new PDCP connection is also established and the process of FIG. 4 begins. However, in another embodiment, the global repair procedure performs an intra-cell handover, in which case the process of FIG. 4 begins after the intra-cell handover.

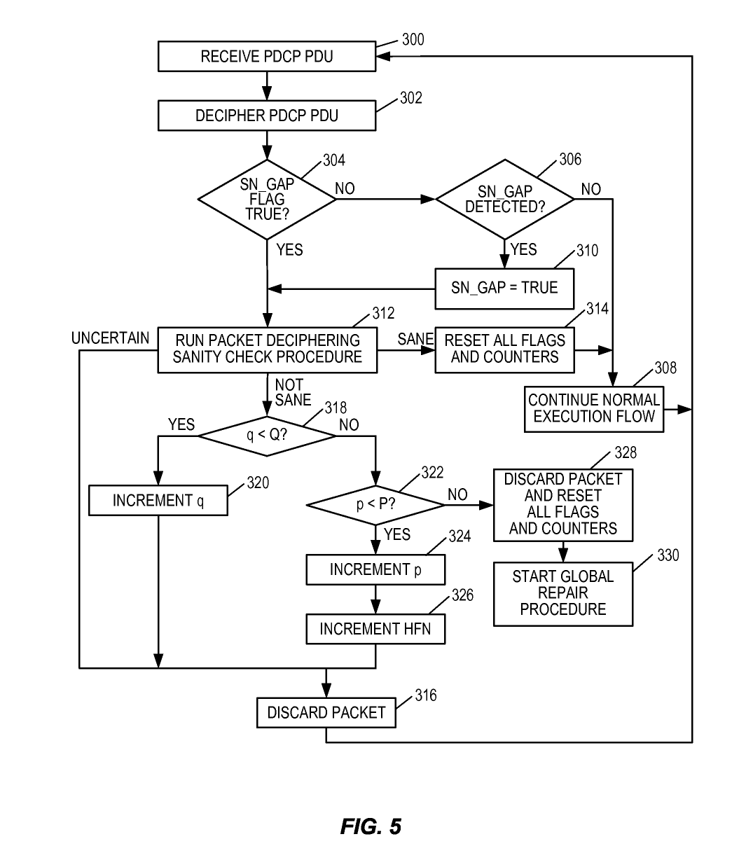

FIG. 5 is a flow chart that illustrates the operation of the radio node 16 of FIG. 2 (e.g., either the base station 12 or the wireless device 14) to perform HFN desynchronization detection and correction according to another embodiment of the present disclosure. This process is performed by the PDCP layer 22. Further, this process is performed for a particular PDCP connection over a single radio bearer between the radio node 16 and another radio node. However, multiple instances of this process may be performed in parallel for multiple PDCP connections over corresponding radio bearers. In other words, the PDCP layer 22 includes one uplink PDCP entity (a PDCP transmitter) and one downlink PDCP entity (a PDCP receiver) per configured radio bearer. Each PDCP receiver performs the process of FIG. 3.

As illustrated, the PDCP layer 22, which in this case is operating as a PDCP receiver, receives a PDCP PDU from a PDCP layer (i.e., a PDCP transmitter) of another radio node (step 300). The PDCP layer 22 then deciphers the PDCP PDU, as discussed above (step 302). In this embodiment, before performing the HFN desynchronization detection and correction process, the HFN desynchronization detection and correction function 24 of the PDCP layer 22 determines whether a PDCP SN gap flag (SN_GAP) is set to TRUE (step 304). Initially, the PDCP SN gap flag (SN_GAP) is set to FALSE. However, as discussed below, once the PDCP layer 22 detects a gap in the PDCP SNs, the PDCP layer 22 sets the PDCP SN gap flag (SN_GAP) to TRUE.

If the PDCP SN gap flag (SN_GAP) is not TRUE (i.e., is FALSE), the PDCP layer 22 determines whether a gap in the PDCP SNs is detected (step 306). A gap in the PDCP SNs is detected when there is a gap between the PDCP SN in the received PDCP PDU and the PDCP SN of the immediately preceding PDCP PDU received by the PDCP layer 22. If no gap is detected, the PDCP layer 22 continues normal execution flow (i.e., normal operation) (step 308), and the process then returns to step 300 and is repeated for the next received PDCP PDU. However, if a gap in the PDCP SNs is detected, the PDCP layer 22 sets the PDCP SN gap flag (SN_GAP) to TRUE (step 310). Note that, in some alternative embodiments, steps 304, 306, and 310 are not performed. In other words, the HFN desynchronization detection is performed on all deciphered PDCP PDUs without first determining if there is a gap in the sequence of PDCP SNs.

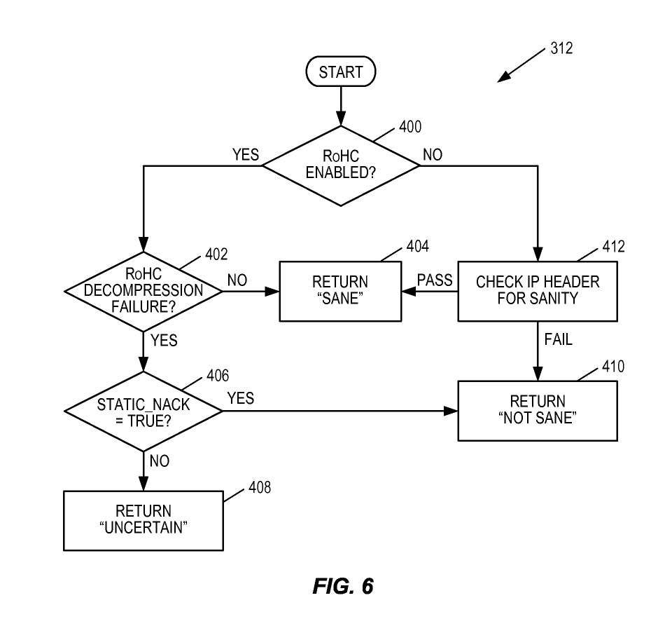

If the PDCP SN gap flag (SN_GAP) is determined to be TRUE in step 304 or if the PDCP SN gap flag (SN_GAP) is set to TRUE in step 310, the HFN desynchronization detection and correction function 24 then triggers a HFN desynchronization detection and correction procedure. By triggering the HFN desynchronization detection and correction procedure only when the PDCP SN gap flag (SN_GAP) is TRUE, processing resources are conserved by not performing the HFN desynchronization detection and correction procedure for all PDCP PDUs. In this embodiment, in order to detect a HFN desynchronization condition, the HFN desynchronization detection and correction function 24 first runs a packet deciphering sanity check procedure, which is discussed below in detail with respect to FIG. 6 (step 312). The sanity check procedure generally operates to inspect the deciphered PDCP PDU to determine whether it is likely that there was an error in deciphering, in which case a HFN desynchronization condition is detected. Notably, as discussed below, the sanity check procedure distinguishes between HFN desynchronization and RoHC context desynchronization.

The sanity check procedure declares, or outputs, one of three conditions, namely, a “sane” condition that indicates that there is no HFN desynchronization condition, an “uncertain” condition, or a “not sane” condition that indicates that, in one embodiment, there is a HFN desynchronization condition. If the sanity check declares a “sane” condition for the deciphered PDCP PDU, the HFN desynchronization detection and correction function 24 resets all HFN desynchronization detection and correction parameters (e.g., SN_GAP and counters q and p) (step 314), and the PDCP layer 22 continues normal execution flow (i.e., normal operation) (step 308). The process then returns to step 300 and is repeated for the next received PDCP PDU.

Returning to step 312, if the sanity check procedure is uncertain as to whether a HFN desynchronization detection condition exists, the HFN desynchronization detection and correction function 24 discards the PDCP PDU (step 316), and the process then returns to step 300 and is repeated for the next received PDCP PDU. Conversely, if the sanity check procedure returns “not sane,” the HFN desynchronization detection and correction function 24 determines whether a counter (q) for the number of consecutive deciphered PDCP PDUs that have failed the sanity check is less than a predefined de-bounding parameter (Q) (step 318). If so, the HFN desynchronization detection and correction function 24 increments the counter (q) (step 320) and discards the PDCP PDU (step 316). At this point, HFN desynchronization is not yet declared. The process then returns to step 300 and is repeated for the next received PDCP PDU. Notably, the predefined de-bounding parameter (Q) delays the incrementing of the HFN maintained by the PDCP layer 22 until there is near certainty that HFN synchronization is lost. The value of Q may be tunable, or configurable, based on one or more parameters such as, e.g., service type (QCI) or other radio bearer attributes. For UM Voice over IP (VoIP) radio bearers, for example, the value of Q may be relatively small as compared to that for very high traffic rate AM radio bearers. Note that, in one embodiment, the counter (q) is reset every time the HFN is incremented.

Some additional considerations for setting the value of Q are as follows. If RoHC is enabled, a RoHC SN repair algorithm is employed by RoHC upon a Cyclic Redundancy Check (CRC) error, as specified in RFC 3095 Chapter 5.3.2.2.3. The value of Q should be chosen to be large enough so that there is near certainty that at least one of the Q PDCP PDU packets is a context repairing packet (e.g. Initiation and Refresh state (IR) RoHC packet type as defined in RFC 3095 section 5.2.7). By doing so, there can be near certainty that there is a HFN desynchronization (rather than a RoHC context desynchronization) before incrementing the HFN. However, as discussed below with respect to FIG. 6, one alternative to setting the value of Q in this manner is to select the value of Q such that, following the sending of a STATIC-NACK feedback from the RoHC decompressor to the RoHC compressor, there is near certainty that at least one of the Q PDCP PDU packets is a context repairing packet (e.g., an IR RoHC packet type).

Returning to step 318, if the counter (q) is not less than Q, the HFN desynchronization detection and correction function 24 declares a HFN desynchronization condition. Before incrementing the HFN to attempt to correct the HFN desynchronization condition, the HFN desynchronization detection and correction function 24 determines whether a counter (p) for the number of HFN correction attempts is less than a predefined maximum number of HFN correction attempts (P) (step 322). The maximum number of HFN correction attempts (P) is a value that provides enough opportunities for the HFN maintained by the PDCP receiver (i.e., the PDCP layer 22 of the (receiving) radio node 16) to “catch up” with the HFN maintained by the PDCP transmitter (i.e., the PDCP layer of the transmitting radio node) in the case of severe HFN desynchronization. Like the value of Q, the value of P may be tunable, or configurable, based on one or more parameters such as, e.g., service type (QCI) or other radio bearer attributes. For UM VoIP radio bearers, for example, the value of P may be relatively small as compared to that for very high traffic rate AM radio bearers.

If the counter (p) is less than the maximum number of HFN correction attempts (P), the HFN desynchronization detection and correction function 24 increments the counter (p) (step 324) and increments the HFN maintained by the PDCP layer 22 (step 326). The HFN desynchronization detection and correction function 24 then discards the PDCP PDU (step 316), and the process then returns to step 300 and is repeated for the next received PDCP PDU. Notably, when deciphering the next received PDCP PDU, the new, or incremented, HFN is utilized.

At step 322, if the counter (p) is not less than the maximum number of HFN correction attempts (P), then the HFN desynchronization detection and correction function 24 declares that the HFN desynchronization condition is irrecoverable. As such, the HFN desynchronization detection and correction function 24 discards the PDCP PDU and resets all flags and counters for the HFN desynchronization detection and correction process (e.g., SN_GAP, q, and p) (step 328) and initiates a global repair procedure (step 330). At this point, the process ends. In particular, the global repair procedure releases the radio bearer, and the PDCP connection is lost. Thereafter, when the radio bearer is re-established, a new PDCP connection is also established and the process of FIG. 5 begins.

FIG. 6 is a flow chart that illustrates the sanity check procedure of step 312 of FIG. 5 according to one embodiment of the present disclosure. When performing the sanity check procedure, the HFN desynchronization detection and correction function 24 first determines whether RoHC is enabled (step 400). If RoHC is enabled, the HFN desynchronization detection and correction function 24 determines whether a RoHC decompression failure occurred in the RoHC function 26 of the PDCP layer 22 for the deciphered PDCP PDU (step 402). A RoHC decompression failure may be detected by the RoHC in response to a RoHC header that is invalid in the current state of the RoHC decompressor or receiving what seems like a valid RoHC header, but the resulting decompressed packet header fails the Cyclic Redundancy Check. The HFN desynchronization detection and correction function 24 interacts with the RoHC function 26 to determine that there was a RoHC decompression failure using any suitable mechanism, e.g., an Application Programming Interface (API). If there was no RoHC decompression failure, the sanity check procedure returns a “sane” condition (i.e., there is no HFN desynchronization condition) (step 404).

In this embodiment, if there was a RoHC decompression failure, the HFN desynchronization detection and correction function 24 determines whether a STATIC-NACK feedback has been generated by the RoHC function 26 (specifically by a RoHC decompressor of the RoHC function 26) (step 406). Note that a STATIC-NACK is generated by the RoHC function 26 after a certain number of unsuccessful RoHC decompressions, as defined in Chapter 5 of RFC 3095. The STATIC-NACK causes the RoHC compressor in the PDCP layer of the transmitting radio node to reset its RoHC state (or context) and send specific RoHC packet type to resynchronize the RoHC decompressor in the PDCP layer 22 of the radio node 16. If after an attempted RoHC synchronization RoHC decompression still fails, then a determination can be made that the RoHC decompression failure is due to HFN desynchronization (i.e., received PDCP PDUs cannot be correctly deciphered). Note that, in one embodiment, once the STATIC-NACK has been generated, a STATIC-NACK flag may be set to TRUE. Then, in step 406, the process checks the STATIC-NACK flag.

As discussed above, as an alternative to waiting for the STATIC-NACK to be generated by the RoHC decompressor, the value of Q (FIG. 5) may be set to a value that is sufficiently large to have near certainty that at least one of the Q packets is a context repairing packet for the RoHC context. By setting Q in this manner, if the “not sane” condition still exists after Q packets, then the HFN desynchronization detection and correction function 24 can be sufficiently certain that a HFN desynchronization condition, rather than a RoHC content desynchronization condition, exists.

Returning to step 406, if a STATIC-NACK has not been generated, the sanity check procedure returns “uncertain” (step 408). The process of FIG. 5 then continues. Once a sufficient number of PDCP PDUs have been processed and corresponding RoHC decompression failures have occurred to cause the RoHC decompressor to generate a STATIC-NACK (i.e., once STATIC-NACK=TRUE), the sanity check procedure returns “not sane” (step 410). At that point, the sanity check procedure is sufficiently certain that the RoHC decompression failure is due to HFN desynchronization rather than RoHC state, or context, desynchronization.

Returning to step 400, if RoHC is not enabled, the IP header of the deciphered PDCP PDU is checked for sanity (step 412). In other words, the IP header is validated. Any suitable mechanism can be used to determine whether the IP header is valid. Further, the mechanism used to determine whether the IP header is valid may be implementation specific. As an example, the validity of the IP header may be determined based on one or more fields in the IP header such as, for instance, IP version, header length, and/or IP header checksum. If the IP header passes the IP header sanity check, the sanity check procedure returns “sane” (i.e., there is no HFN desynchronization) (step 404). Otherwise, if the IP header fails the IP header sanity check, the sanity check procedure returns “not sane” (i.e., there is HFN desynchronization) (step 410).

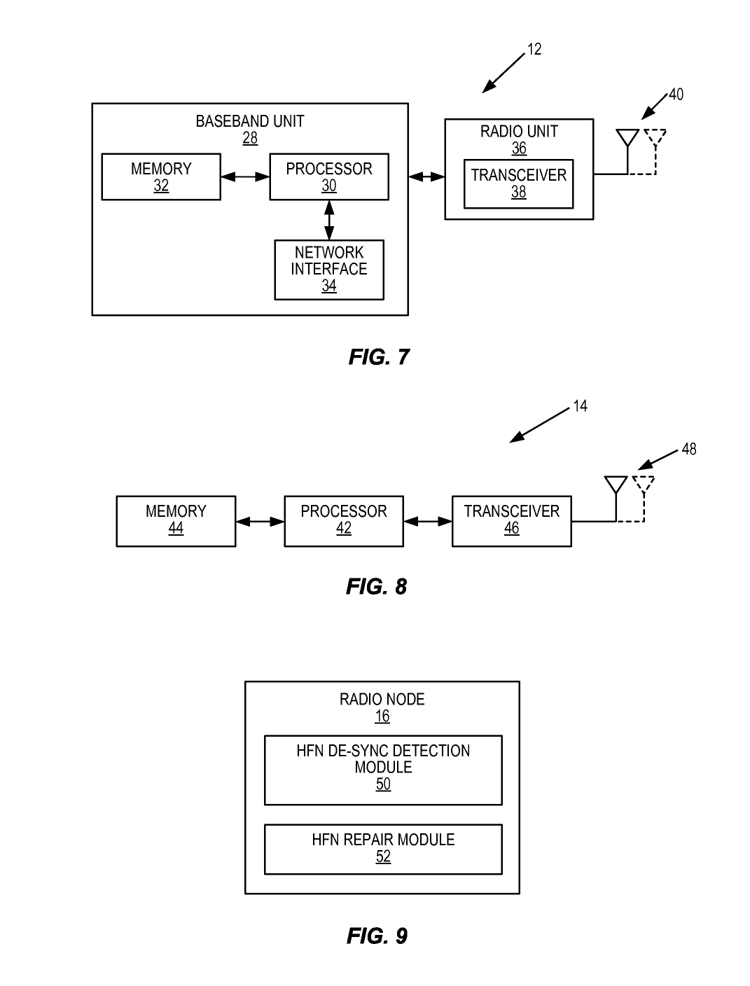

The radio node 16 can be implemented in any suitable hardware or combination of hardware and software. Using the base station 12 and the wireless device 14 of FIG. 1 as examples, FIG. 7 is a block diagram of one embodiment of the base station 12, and FIG. 8 is a block diagram of one embodiment of the wireless device 14. As illustrated in FIG. 7, the base station 12 includes a baseband unit 28 including a processor 30, memory 32, and a network interface 34 and a radio unit 36 including a transceiver 38 coupled to one or more antennas 40. In one embodiment, the functionality of the base station 12 described herein (particularly that of the PDCP layer 22) is implemented in software stored in the memory 32 and executed by the processor 30. Additionally, the base station 12 may include additional components responsible for providing additional functionality, including any of the functionality described above and/or any functionality necessary to support the embodiments described herein.

As illustrated in FIG. 8, the wireless device 14 includes a processor 42, memory 44, and a transceiver 46 coupled to one or more antennas 48. In one embodiment, the functionality described above as being provided by the wireless device 14 (and in particular the PDCP layer 22) may be provided by the processor 42 executing instructions stored on a computer-readable medium, such as the memory 44. Alternative embodiments of the wireless device 14 may include additional components responsible for providing additional functionality, including any of the functionality identified above and/or any functionality necessary to support the embodiments described above.

FIG. 9 is a block diagram of a radio node 16, e.g., either the base station or the wireless device of FIG. 1, according to one embodiment of the present disclosure. In this embodiment, the radio node 16 includes a HFN desynchronization detection module 50 and a HFN repair module 52, each of which is implemented in software stored on a computer readable medium (e.g., the memory 32 or 44) that when executed by a processor (e.g., the processor 30 or 42) causes the radio node 16 to operate according to any of the embodiments described above. The HFN desynchronization module 50 generates operates to detect a HFN desynchronization event, as discussed above. The HFN repair module 52 operates to attempt to repair a HFN desynchronization event by, e.g., incrementing the HFN, as discussed above.

In one embodiment, a computer program is provided that includes instructions which, when executed on at least one processor, cause the at least one processor to carry out any of the embodiments of the radio node 16 (e.g., the base station 12 or the wireless device 14) described above. In one embodiment, a carrier containing the computer program is provided, wherein the carrier is one of an electronic signal, an optical signal, a radio signal, or a computer readable storage medium (e.g., a non-transitory computer readable medium).

Embodiments of the present disclosure are particularly well suited for, but not limited to, UM radio bearers configured to run with a short (e.g., 7-bit) PDCP SN (such as VoIP (e.g., Voice over LTE (VoLTE)) or video streaming) as well as high data rate AM radio bearers where large blocks of packets may potentially be discarded (e.g., at the cell-edge or in re-establishment scenarios). Further, embodiments disclosed herein are designed to work on RoHC-enabled data radio bearers as well as RoHC-disabled data radio bearers.

Embodiments of the present disclosure may provide numerous advantages. While not being limited to any particular advantage, some examples are provided below. At a high level, some embodiments of the present disclosure provide increased coverage and availability of cellular network service provided by the cellular network 10 of FIG. 1, as well as improved quality of experience for users in poor radio conditions. Using conventional HFN desynchronization recovery mechanisms, the radio bearer must be terminated and then reinitiated. In contrast, the embodiments disclosed herein enable detection and recovery from HFN desynchronization without terminating the radio bearer.

While HFN desynchronization may be mitigated by using long PDCP SNs (e.g., 12 bit PDCP SNs or higher) even when running in UM, the extra bits of PDCP (and Radio Link Control (RLC)) SNs add overhead that might not be acceptable to the network operator, especially in narrow spectrum deployments. The long SN is a “tax” that is paid even by the wireless devices that are in good radio conditions. The embodiments disclosed herein avoid the need to use long PDCP SNs to mitigate HFN desynchronization.

Another advantage of the embodiments disclosed herein is the fact that no signaling exchange is required between the two radio nodes to correct HFN desynchronization. The HFN desynchronization detection and correction schemes disclosed herein are performed in the PDCP layer and do not require any signaling messages (e.g., do not require any RRC signaling messages). This makes the HFN desynchronization detection and recovery schemes disclosed herein lightweight and fast. Further, any exchange of messages between the radio nodes for the purpose of synchronizing the HFN would be a security vulnerability. Yet another advantage is that embodiments the present disclosure do not introduce interoperability constraints between the wireless device 14 and the base station 12 and, therefore, may be implemented only in the base station 14 or only in the wireless device 12.

The following acronyms are used throughout this disclosure.
3GPP 3^{rd} Generation Partnership Project
AM Acknowledged Mode
API Application Programming Interface
CRC Cyclic Redundancy Check
eNB Evolved Node B
HFN Hyper Frame Number
ID Identifier
IETF Internet Engineering Task Force
IP Internet Protocol
IR Initiation and Refresh State
LI Length Indicator
LTE Long Term Evolution
PDCP Packet Data Convergence Protocol
PDU Packet Data Unit
RF Radio Frequency
RFC Request for Comment
RLC Radio Link Control
RoHC Robust Header Compression
RRC Radio Resource Control
SN Sequence Number
TS Technical Specification
UE User Equipment
UM Unacknowledged Mode
VoIP Voice over Internet Protocol
VoLTE Voice over Long Term Evolution
WCDMA Wideband Code Division Multiple Access

Those skilled in the art will recognize improvements and modifications to the embodiments of the present disclosure. All such improvements and modifications are considered within the scope of the concepts disclosed herein and the claims that follow.

What is claimed is:

1. A method of operation of a first radio node, comprising:
receiving a Packet Data Convergence Protocol, PDCP, packet data unit from a second radio node;
deciphering the PDCP packet data unit based on a PDCP sequence number contained in the PDCP packet data unit and a Hyper Frame Number, HFN, maintained at the first radio node;
detecting a PDCP sequence number gap with respect to the PDCP sequence number included in the PDCP packet data unit;
in response to detecting that there is a PDCP sequence number gap, determining whether a HFN desynchronization condition exists between the first radio node and the second radio node; and
in response to determining that a HFN desynchronization condition exists between the first radio node and the second radio node, incrementing the HFN maintained at the first radio node.

2. The method of claim 1 further comprising:
receiving a new PDCP packet data unit from the second radio node;
deciphering the new PDCP packet data unit based on a PDCP sequence number contained in the new PDCP packet data unit and the HFN;
determining that the HFN desynchronization condition still exists between the first radio node and the second radio node; and
in response to determining that the HFN desynchronization condition still exists, further incrementing the HFN maintained at the first radio node.

3. The method of claim 1 further comprising repeating a process of receiving a new PDCP packet data unit from the second radio node, deciphering the new PDCP packet data unit based on a PDCP sequence number contained in the new PDCP packet data unit and the HFN maintained by the first radio node, determining whether the HFN desynchronization condition still exists, and further incrementing the HFN maintained by the first radio node if the HFN desynchronization condition still exists until either the HFN desynchronization condition no longer exists or a maximum number of HFN correction attempts has been reached.

4. The method of claim 3 further comprising, if the HFN desynchronization condition still exists and the maximum number of HFN correction attempts has been performed, initiating a global repair procedure to thereby repair the HFN desynchronization condition.

5. The method of claim 4 wherein the global repair procedure comprises one of a group consisting of: re-establishment or radio bearer release.

6. The method of claim 1 wherein determining whether the HFN desynchronization condition exists comprises performing a HFN desynchronization detection procedure that distinguishes between HFN-desynchronization and Robust Header Compression, RoHC, context desynchronization.

7. The method of claim 1 wherein determining whether the HFN desynchronization condition exists comprises:
determining whether Robust Header Compression, RoHC, is enabled; and
if RoHC is enabled:
determining that a STATIC-NACK feedback is generated at the first radio node; and
after determining that the STATIC-NACK feedback is generated at the first radio node, determining that the HFN desynchronization condition exists in response to a RoHC decompression failure for each of a predefined number, Q, of successive deciphered PDCP packet data units received from the second radio node.

8. The method of claim 7 wherein determining whether the HFN desynchronization condition exists further comprises:
if RoHC is not enabled, determining whether the HFN desynchronization condition exists based on an Internet Protocol, IP, header of the deciphered PDCP packet data unit.

9. The method of claim 1 wherein determining whether the HFN desynchronization condition exists comprises:
determining whether Robust Header Compression, RoHC, is enabled; and
if RoHC is enabled:
determining that there is a RoHC decompression failure for the deciphered PDCP packet data unit;
determining that a RoHC decompressor of the first radio node has generated a STATIC-NACK message;
declaring the deciphered PDCP packet data unit as not sane; and
repeating a process of receiving a new PDCP packet data unit from the second radio node, deciphering the PDCP packet data unit based on a PDCP sequence number contained in the new PDCP packet data unit and the HFN maintained at the first radio node, determining that there is a RoHC decompression failure for the deciphered new PDCP packet data unit, determining that the RoHC decompressor of the first radio node has generated a STATIC-NACK message, and declaring the deciphered new PDCP packet data unit as not sane until a number, q, of successive deciphered PDCP packet data units received from the second radio node that have been declared not sane is equal to a predefined threshold, Q, at which point the HFN desynchronization condition is determined to exist.

10. The method of claim 9 wherein the predefined threshold, Q, is greater than 1.

11. The method of claim 9 wherein determining whether the HFN desynchronization condition exists further comprises:
if RoHC is not enabled, determining whether the HFN desynchronization condition exists based on an Internet Protocol, IP, header of the deciphered PDCP packet data unit.

12. The method of claim 1 wherein the method of operation of the first radio node is a method of operation of the first radio node in a Long Term Evolution, LTE, network.

13. A first radio node, comprising:
a transceiver;
a processor; and
memory containing instructions executable by the processor by whereby the first radio node is operative to:
receive, via the transceiver, a Packet Data Convergence Protocol, PDCP, packet data unit from a second radio node;
decipher the PDCP packet data unit based on a PDCP sequence number contained in the PDCP packet data unit and a Hyper Frame Number, HFN, maintained at the first radio node;
detect a PDCP sequence number gap with respect to the PDCP sequence number included in the PDCP packet data unit; and
in response to detecting that there is a PDCP sequence number gap, determine whether a HFN desynchronization condition exists between the first radio node and the second radio node; and
in response to determining that a HFN desynchronization condition exists between the first radio node and the second radio node, increment the HFN maintained at the first radio node.

14. The first radio node of claim 13, wherein by the instructions executable by the processor, the first radio node is further operative to:
receive, via the transceiver, a new PDCP packet data unit from the second radio node;
decipher the new PDCP packet data unit based on a PDCP sequence number contained in the new PDCP packet data unit and the HFN;
determine that the HFN desynchronization condition still exists between the first radio node and the second radio node; and
in response to determining that the HFN desynchronization condition still exists, further increment the HFN maintained at the first radio node.

15. The first radio node of claim 13, wherein by the instructions executable by the processor, the first radio node is further operative to:
repeat a process of receiving a new PDCP packet data unit from the second radio node, deciphering the new PDCP packet data unit based on a PDCP sequence number contained in the new PDCP packet data unit and the HFN maintained by the first radio node, determining whether the HFN desynchronization condition still exists, and further incrementing the HFN maintained by the first radio node if the HFN desynchronization condition still exists until either the HFN desynchronization condition no longer exists or a maximum number of HFN correction attempts has been reached.

16. The first radio node of claim 15 wherein by the instructions executable by the processor, the first radio node is further operative to:
if the HFN desynchronization condition still exists and the maximum number of HFN correction attempts has been performed, initiate a global repair procedure to thereby repair the HFN desynchronization condition.

17. The first radio node of claim 16 wherein the global repair procedure comprises one of a group consisting of: re-establishment or radio bearer release.

18. The first radio node of claim 13, wherein by the instructions executable by the processor, the first radio node is further operative to, in order to determine whether the HFN desynchronization condition exists, perform a HFN desynchronization detection procedure that distinguishes between HFN-desynchronization and Robust Header Compression, RoHC, context desynchronization.

19. The first radio node of claim 13, wherein by the instructions executable by the processor, the first radio node is further operative to, in order to determine whether the HFN desynchronization condition exists:
determine whether Robust Header Compression, RoHC, is enabled; and
if RoHC is enabled,
determine that a STATIC-NACK feedback is generated at the first radio node; and
determine that the HFN desynchronization condition exists in response to a RoHC decompression failure for each of a predefined number, Q, of successive deciphered PDCP packet data units received from the second radio node.

20. The first radio node of claim 19, wherein by the instructions executable by the processor, the first radio node is further operative to, in order to determine whether the HFN desynchronization condition exists:
if RoHC is not enabled, determine whether the HFN desynchronization condition exists based on an Internet Protocol, IP, header of the deciphered PDCP packet data unit.

21. The first radio node of claim 13, wherein by the instructions executable by the processor, the first radio node is further operative to, in order to determine whether the HFN desynchronization condition exists:
determine whether Robust Header Compression, RoHC, is enabled; and
if RoHC is enabled:
determine that there is a RoHC decompression failure for the deciphered PDCP packet data unit;
determine that a RoHC decompressor of the first radio node has generated a STATIC-NACK message;
declare the deciphered PDCP packet data unit as not sane; and
repeat a process of receiving a new PDCP packet data unit from the second radio node, deciphering the PDCP packet data unit based on a PDCP sequence number contained in the new PDCP packet data unit and the HFN maintained at the first radio node, determining that there is a RoHC decompression failure for the deciphered new PDCP packet data unit, determining that the RoHC decompressor of the first radio node has generated a STATIC-NACK message, and declaring the deciphered new PDCP packet data unit as not sane until a number, q, of successive deciphered PDCP packet data units received from the second radio node that have been declared not sane is equal to a predefined threshold, Q, at which point the HFN desynchronization condition is determined to exist.

22. The first radio node of claim 21 wherein the predefined threshold, Q, is greater than 1.

23. The first radio node of claim 21 wherein by the instructions executable by the processor, the first radio node is further operative to, in order to determine whether the HFN desynchronization condition exists:
if RoHC is not enabled, determining whether the HFN desynchronization condition exists based on an Internet Protocol, IP, header of the deciphered PDCP packet data unit.
